(19) United States
(12) Patent Application Publication
(10) Pub. No.: US 2017/0105491 A1
(43) Pub. Date: Apr. 20, 2017

(54) MILLING HEAD AND METHOD OF USING SAME

(71) Applicant: AMFIT, INC., Vancouver, WA (US)

(72) Inventor: Arjen SUNDMAN, Portland, OR (US)

(21) Appl. No.: 15/264,673

(22) Filed: Sep. 14, 2016

Related U.S. Application Data
(60) Provisional application No. 62/242,038, filed on Oct. 15, 2015.

(51) Int. Cl. A43D 8/02; B23C 5/10

(52) U.S. Cl. CPC A43D 8/02; B23C 5/10; B23C 2210/202; B23C 2210/247; B23C 2210/54; B23C 2228/14

(57) ABSTRACT

Disclosed is a milling head for shaping a shoe support for an article of foot wear. The disclosed milling head includes abrasive surfaces that are configured to allow for the shaping of an unfinished block of support material on all of the top, side and medial arch area of the perimeter surfaces without removing the block of support material from a support such as a vacuum vise, and without the need to interchange milling heads. The disclosed milling head has a semi-spherical milling surface for milling a top surface of the shoe support and two conical milling surfaces for milling a perimeter surface and a medial arch area of the perimeter surface of the shoe support, respectively. The disclosed milling head saves costs of labor and time when shaping the block of support material.

### CROSS-REFERENCED APPLICATION

This application is a related, and claims priority, to U.S. Provisional Application Ser. No. 62/242,038 filed on Oct. 15, 2015 that is incorporated herein in its entirety by reference thereto.

### BACKGROUND OF THE DISCLOSURE

1. Field of the Disclosure

This disclosure relates to a milling head for shaping a shoe support from an unfinished block of support material. More particularly, the present disclosure relates to a milling head that comprises multiple cutting/grinding surfaces that can shape the shoe support on all surfaces requiring shaping, including the top, perimeter and medial arch area of the perimeter surface, without moving the support material from a vacuum vise or other device holding it. The present disclosure also relates to a method of using the disclosed milling head to shape the unfinished block of support material.

2. Description of the Related Art

In the manufacture of custom shoe supports, there are a number of surfaces that must be customized to produce a finished support from an unfinished block of support material. These surfaces include a contoured top surface, a perimeter surface and a medial arch area of the perimeter surface of the unfinished block of support material.

The contoured top surface supports the foot itself. It is generally designed for contouring using a digitized set of contour data that represent the shape of the foot, including possible corrections/edits to that contour data that may be desired for the final finished support. This contoured top surface is generally machined into an oversized unfinished block of support material using a semi-spherical grinding or milling tool under computer control. This is known in the art as CNC-type technology. Generally, this provides the desired customized top surface of the support.

However, at the present time, the CNC-type technology is the only automation generally employed to customize a shoe support, with the balance of the required surface customization (i.e., the perimeter surface shape and the shape of the medial arch area of the perimeter surface) generally performed by hand. Customizing the perimeter surface and medial arch area of the perimeter surface by hand is time consuming, fraught with the potential for errors and, in any case, requires a skilled manual laborer to successfully complete the custom support.

Attempts to use the semi-spherical grinding or milling tool to also grind the perimeter surface of the oversized unfinished block of support material provides at best a marginal solution. The reason for this is that the semi-spherical grinding/milling tool has a ball-shaped (i.e., semi-spherically curved) end that will not produce a clean angled or vertical perimeter surface on the oversized unfinished block of support material. A possible solution to this problem could be to provide a tool changer that would allow the perimeter surface to be shaped using a milling head that has a squared-off milling profile. This could provide a clean perimeter surface but it will not shape the perimeter surface all the way to the medial arch area of the unfinished block of support material because, in the present state of the art, all support materials that require customization are either adhered to or held under vacuum to the milling machine surface. This makes shaping the perimeter surface through the cross-sectional depth of the unfinished block of support material impractical. Further, it is generally desirable (if not necessary) for the perimeter surface of the customized shoe support to have an undercut of typically about 7-12 degrees (7°-12°) so as to facilitate a better and easier fit for the shoe support into the shoe. In theory, a specialized milling tool might make this possible using a tool changer to replace the semi-spherical grinding/milling tool with the specialized tool but, again, it is not possible to cut through the entire cross-sectional depth of the unfinished block of support material, resulting in making additional hand sanding a necessary operation.

Lastly, there is presently no solution as to how to remove excess material from the medial arch area of the perimeter surface of the unfinished block of support material in the arch region. Removing the partly finished block of support material from the vacuum vise and turning it over to expose the arch area followed by machining the medial arch area of the perimeter surface will not work because the top surface has already been machined and has an uneven surface, making for firm gripping by the vacuum vise highly problematic. Moreover, the remaining partly finished support is highly flexible, making securing the partly finished block of support material difficult and making additional automated machining impractical. Further, even if the issue of fixing the highly flexible material could be solved, there remains the problem of having an operator manually turning over the material and locating it precisely in the vacuum vise so that machining the medial arch area of the perimeter surface can be performed in precisely the right location. It could also be possible to use a simple ball end milling head by affixing the unfinished block of support material to a mechanism to tilt the insole or spindle to grind the side angles for the medial arch area. However, this would entail a complex mechanism for tilting and precise control of the tilt angle which, in any event would likely not produce the correct undercut angle and, in addition, would still be less than desirable from a finished product point of view since the ball milling end curvature would not produce the necessary uniform undercut.

The foregoing problems can in theory be resolved by maintaining the unfinished block of support material fixed to the milling machine surface and performing all perimeter and undercut operations from the top. Therefore, there exists a need in the art for a device and method that can perform all perimeter surface and medial arch area of the perimeter surface milling operations from the top. The method and device of the present disclosure satisfies those needs.

### SUMMARY OF THE DISCLOSURE

It is an object of the present disclosure to provide a device and method that can shape the perimeter surface of an unfinished block of support material through the cross-sectional depth to the medial arch area of the perimeter surface thereof without requiring moving the material from a known position in the vacuum vise, on the milling machine surface, or in another holding device.

It is another object of the present disclosure to provide a device and method that can shape the medial arch area of the perimeter surface in the arch area of an unfinished block of support material without requiring moving the material from position in the vacuum vise, on the milling machine surface, or in another holding device.

It is also an object of the present disclosure to provide a device and method that can fully automate the manufacture of a customized shoe support.

These and other objects are provided by a milling head according to the present disclosure.

In one embodiment, the present disclosure provides a milling head having a plurality of milling surfaces for forming a shoe support from an unfinished block of support material, the plurality of milling surfaces comprising at least a first angled undercutting surface; and a curved surface, wherein each of the at least a first angled undercutting surface and curved surface is provided with a cutting surface, wherein the at least first angled undercutting surface is configured to perform milling a milling operation on a perimeter surface of the unfinished block of support material, and wherein the curved surface is configured to perform milling on a top surface of the unfinished block of support material.

In another embodiment, the present disclosure provides a milling head having a plurality of milling surfaces for forming a shoe support from an unfinished block of support material, the plurality of milling surfaces comprising at least a first angled undercutting surface, at least a second angled undercutting surface, and a curved surface, wherein each of the at least first angled surface, the at least second angled undercutting surface and the curved surface has a cutting surface, wherein the first angled undercutting surface is configured to perform milling on a perimeter surface of the unfinished block of support material, wherein the second angled undercutting surface is configured to perform milling on a medial arch area of the perimeter surface of the unfinished block of support material, and wherein the curved surface is configured to perform milling on a top surface of the unfinished block of support material.

Preferably, the milling head further comprises a chuck shaft configured for insertion into a drill chuck, wherein the curved surface is disposed distal the chuck shaft and wherein the first and second angled undercutting surfaces are disposed between the chuck shaft and the curved surface. Also preferably, the plurality of milling surfaces and, optionally, the chuck shaft, are of a unitary structure, although one or more of each milling surface may be releasably connectable to one or more other milling surface(s) and/or the chuck shaft, such as by threading, spring clip, set screws, spring loaded locking pin or similar attachment elements known to those of skill in the art. The milling head is preferably configured to perform the milling of the perimeter surface, medial arch area of the perimeter surface and top surface by rotation, preferably high speed rotation, by the use of computer guided drill assembly, but may also be configured to perform the milling of the perimeter surface, medial arch area of the perimeter surface and top surface of the unfinished block of support material by oscillation or vibration, as is known to those of skill in the art. As will be understood by those of skill in the art, where the milling head performs milling by rotation, each of the first and second cutting surfaces and the curved surface will preferably have a substantially circular cross-section through a longitudinal axis of the milling head running along the length of the milling head. As will also be understood by those of skill in the art, where the milling head performs cutting by oscillation, each of the first and second cutting surfaces and the curved surface will preferably have a substantially planar configuration.

As used herein, the “first” and “second” angled surfaces and/or the “curved” surface need not necessarily be distinct or separate. These surfaces (and especially the “first” and “second” angled surfaces) can be provided by, for example, a continuously curved surface in a parabolic-type configuration proceeding from one end of the milling head to the other. In this configuration, the “angle” of any point on the surface would be defined by the angle between a longitudinal axis passing through the length of the milling head and a tangent to the continuously curved surface that is being considered. Those of skill in the art will also appreciate that the angled surfaces may be reversed, i.e., the “angled” surface configured to perform milling on a perimeter surface of the unfinished block of support material may be disposed in reverse order on the milling head in relation to the “angled” undercutting surface configured to perform milling on a medial arch area of the perimeter surface of the unfinished block of support material. In other words, the “angled” undercutting surface configured to perform milling on a medial arch area of the perimeter surface of the unfinished block of support material could be disposed further from the chuck shaft end of the milling head than the “angled” surface configured to perform milling on a perimeter surface of the unfinished block of support material. In practice, this configuration is less preferred because, given the increased angle generally needed to perform the undercutting on the medial arch area of the perimeter surface, the greater the mass of that portion of the milling head. This configuration would place a higher mass further from the chuck shaft end which, in turn, could reduce the stability/efficiency of the milling head.

In another embodiment, the present disclosure provides a milling head having a plurality of milling surfaces for forming a shoe support from an unfinished block of support material, the milling head comprising a chuck shaft end and a top surface milling end, at least two undercutting milling surfaces disposed between the chuck shaft end and the top surface milling end, wherein each of the top surface and at least two undercutting surfaces has a cutting surface, wherein the top surface milling end comprises a semi-spherical milling surface, wherein the at least two undercutting milling surfaces comprise at least a first conical milling surface for milling a perimeter surface of the unfinished block of shoe support material and at least a second conical milling surface for milling a medial arch area of the perimeter surface of the unfinished block of shoe support material. Preferably, the at least first conical milling surface is disposed adjacent the semi-spherical top surface milling end and the at least second conical milling surface is disposed adjacent the chuck shaft end. Also preferably, the plurality of miffing surfaces and, optionally, the chuck shaft, are of a unitary structure, although one or more of each milling surface may be connectable to one or more other milling surface and/or the chuck shaft, such as by threading, spring clip, set screws, spring loaded locking pin or similar attachment elements known to those of skill in the art. The milling head is preferably configured to perform milling of the perimeter surface, medial arch area of the perimeter surface and top surface by rotation, preferably high speed rotation, by use of a computer guided drill assembly, but may also be configured to perform the milling of the perimeter surface, medial arch area of the perimeter surface and top surface of the unfinished block of support material by oscillation or vibration, as is known to those of skill in the art. As will be understood by those of skill in the art, where the milling head performs milling by rotation, each of the first and second cutting surfaces and the curved surface will preferably have a substantially circular cross-section through a longitudinal axis of the milling head running along the length of the milling head. As also will be understood by those of skill in the art, where the milling head performs cutting by oscillation, each of the first and second cutting surfaces and the curved surface will preferably have a substantially planar configuration.

The cutting surface is preferably an abrasive surface, but can be a knife-like cutting surface as in a standard drill bit, or can be in the configuration of saw teeth. When an abrasive surface is used, it is generally preferred to use an abrasive having a relatively coarse grit, such as 40-100 grit, preferably 40-80 grit, and more preferably 60-80 grit. A more coarse grit is preferred since the unfinished block of support material is, generally, relatively rigid and hard. However, it will be appreciated by those of skill in the art that a less coarse grit may be used, it being understood that a less coarse grit will entail a longer cutting/shaping time and is, therefore, less efficient.

In a further embodiment, the present disclosure provides a method of forming a shoe support from an unfinished block of support material, the method comprising: (1) providing a milling head comprising a first angled undercutting surface, a second angled undercutting surface and a curved surface, wherein each surface is coated with an abrasive, (2) placing an unfinished block of shoe support material in a position on a support for the unfinished block of shoe support material, wherein the unfinished block of shoe support material has a top surface, a perimeter surface and a medial surface, (3) shaping the top surface with the curved surface, (4) undercutting the perimeter surface with the first angled undercutting surface, and (5) undercutting the medial arch area of the perimeter surface with the second angled undercutting surface, wherein the shaping of the top surface, the undercutting of the perimeter surface and the undercutting of the medial surface is performed by moving the milling head in any combination of an X direction, a Y direction and a Z direction, and wherein the undercutting of the perimeter surface and the undercutting of the medial arch area of the perimeter surface are performed without removing the shoe support material from position on the support.

Preferably, the support is a vacuum vise (as shown in the accompanying Figures), but can be any support that holds the unfinished block of shoe support material firmly in place and provides for exposing the perimeter and medial arch surfaces sufficiently to the action of the milling head. Other possibilities for the support include a pedestal to which the unfinished block of support material is adhered with a temporary but strong adhesive, or providing a keying mechanism on the support material that cooperates with a reciprocal keying mechanism on the support. In this last-mentioned embodiment, the unfinished block of support material can be “locked” into place for milling and “unlocked” once milling is complete. Other possible methods of supporting the unfinished block of support material for milling will be apparent to those of skill in the art. As used herein “holds firmly in place” means that the unfinished block of shoe support material will remain in position and not shift on the support during the milling operation.

Also, as will be understood by those of skill in the art, although the steps in the above method have been referred to using numerical values, the method steps need not be performed in any particular sequence.

In a still further embodiment, the present disclosure provides a method of forming a shoe support from an unfinished block of support material, the method comprising: (1) providing a milling head having a chuck shaft end, a semi-spherical milling surface, a first conical milling surface, and a second conical milling surface, wherein the semi-spherical milling surface is disposed distal to the chuck shaft end, wherein the first and second conical milling surfaces are disposed between the chuck shaft end and the semi-spherical milling surface, wherein each of the semi-spherical milling surface, first conical milling surface and second conical milling surface is coated with an abrasive; (2) placing an unfinished block of shoe support material in a position on a vacuum vise to support the shoe support material, wherein the unfinished block of shoe support material has a top surface, a perimeter surface and a medial surface, (3) shaping the top surface with the semi-spherical milling surface curved surface, (4) undercutting the perimeter surface with the first conical milling surface, and (5) undercutting the medial arch area of the perimeter surface with the second conical milling surface, wherein the shaping of the top surface, the undercutting of the perimeter surface and the undercutting of the medial arch area of the perimeter surface is performed by moving the milling head in any combination of an X direction, a Y direction and a Z direction, and wherein the undercutting of the perimeter surface and the undercutting of the medial arch area of the perimeter surface are performed without removing the shoe support material from position on the vacuum vise.

Each of the at least first angled undercutting surface and the at east second angled undercutting surface is provided with cutting surfaces having angles that are desired for shaping the perimeter surface and medial arch area of the perimeter surface of the unfinished block of material, respectively. The angled cutting surface for providing the desired perimeter surface typically provides an undercut angle to the shoe support material of from about 5° to about 20°, preferably from about 7° to about 15°, more preferably from about 8° to about 12° and most preferably about 10°. It will be understood by those of skill in the art that the recited angles are merely exemplary in nature and that the configuration of the angled surface for providing the desired perimeter surface can vary greatly and, in any event, is defined by the shape of the shoe support for a particular end user. The angled cutting surface for providing the desired medial arch area of the perimeter surface may have an angle similar to that provided for the milling surface for providing the perimeter surface but, in general, has a greater maximum angle that can be greater than 20°, preferably from about 20° to about 45°, more preferably from about 25° to about 40° and most preferably from about 30° to about 40°. A difference between the at least one angled milling surface for providing the perimeter surface and the at least one angled milling surface for providing the medial arch area of the perimeter surface is that the depth of the angled milling surface (measured, for example, by the distance from a longitudinal axis of the milling head passing through the length of the milling head from the, e.g., chuck shaft end to the semi-spherical milling surface) for undercutting the medial arch area of the perimeter surface is greater than the angled milling surface for providing the perimeter surface. By this configuration, the undercutting angled milling surface for providing the medial arch area of the perimeter surface can be run along the perimeter surface of the shoe support material and be driven inwards (i.e., toward the interior of the shoe support material) of the perimeter surface to undercut the arch area of the finished shoe support. The depth of this cut may be determined by the desired shape of the final shoe support and/or the arch height of the subject foot that the shoe support is for. The latter is desired as feet have widely varying arch heights. The undercut for a low arch for instance will in many cases be different than that for a high arch.

With respect to the at least one conical milling surfaces, as is known in geometry, a conical surface can be defined as the unbounded surface formed by the union of all the straight lines passing through a fixed point (the apex) and any point of some fixed space circle a distance from the apex. Stated otherwise, the angle of the conical milling surfaces can be defined as sweeping a line that defines a profile of the edge of the conical surface disposed away from the center of a longitudinal axis through 360 degrees. The angles that were described above can be applied to the conical milling surfaces in terms of angles disposed away from perpendicularity to the straight line connecting the apex and the center of the circle that defines the conical surface. Other than the geometric rules applying to conical surfaces, the description above with respect to the angled surfaces applies equally to the conical surfaces.

With respect to the curved surface and semi-spherical milling surface, the curvature of each can be described in terms of the diameter of the circle that would be formed by the curved surface, and the diameter of the sphere that would be formed by the semi-spherical milling surface. Of course, as will be understood by those of skill in the art, the particular diameter being selected for the curved and/or semi-spherical surface is a matter of design choice and depends upon the top surface that is to be formed on the unfinished block of shoe support material. By way of example, the diameter may be anywhere from ½ inch to 4 inches, preferably ½ inch to 2 inches and, more preferably, 1-2 inches. In the embodiment shown in the Figures, the semi-spherical surface is approximately ½ inch radius.

### BRIEF DESCRIPTION OF THE DRAWINGS

The device and method according to the present disclosure will be more fully understood by reference to the following Figures in which like elements are referred to by like numerals throughout.

FIG. 1 is a side perspective view of a milling head according to a preferred embodiment of the present disclosure.

FIG. 2 is an overhead perspective view of the milling head of FIG. 1 according to a preferred embodiment of the present disclosure in a drill chuck disposed above a vacuum vise work bed.

FIG. 3 is an overhead perspective view of what is shown in FIG. 2, but including an unfinished block of shoe support material supported in place on the vacuum vise work bed.

FIG. 4 is a rear perspective view of the milling head of FIG. 1 in the process of contouring a top surface of the unfinished block of shoe support material as shown in FIG. 3.

FIG. 5 is a front perspective view of the milling head of FIG. 1 in the process of contouring a top surface of the unfinished block of shoe support material as shown in FIG. 4.

FIG. 6 is a rear perspective view of the milling head of FIG. 1 in the process of contouring a perimeter surface of the unfinished block of shoe support material as shown in FIG. 3.

FIG. 7 rear perspective view of the milling head of FIG. 1 contouring a medial arch area of the perimeter surface of the unfinished block of shoe support material as shown in FIG. 3.

### DETAILED DESCRIPTION OF THE PREFERRED EMBODIMENT

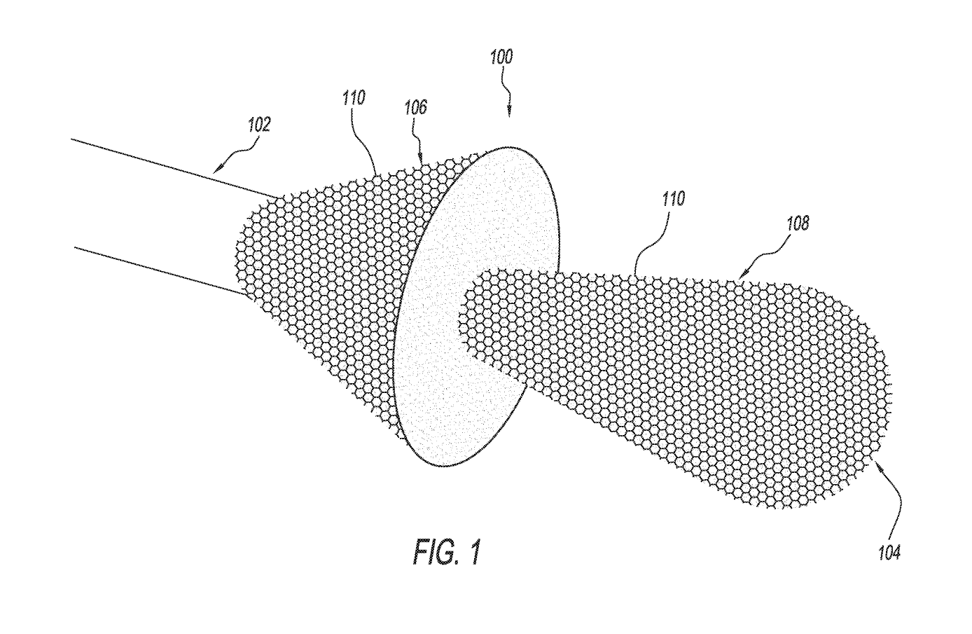

FIG. 1 shows a preferred milling head 100 according to the present disclosure. Milling head 100 has a chuck shaft end 102 and, disposed distally from chuck shaft end 102, a semi-spherical milling surface 104. Disposed between chuck shaft end 102 and semi-spherical milling surface 104 are two conical milling surfaces, a first conical milling surface 106 disposed proximal to chuck shaft end 102 and a second conical milling surface 108 disposed proximal to and integral with semi-spherical milling surface 104. In the embodiment shown in FIG. 1, first conical milling surface 106 has a more pronounced angled conical surface than second conical milling surface 108. As will be described in more detail in relation to other FIGS., in the embodiment shown in FIG. 1 first conical milling surface 106 is configured to undercut a medial arch area of the perimeter surface of an unfinished block of support material. Similarly, in the embodiment shown in FIG. 1, second conical milling surface 108 is configured to undercut a perimeter surface of an unfinished block of support material. Of course, the positions of first conical milling surface 106 and second conical milling surface 108 could be interchanged. Each of semi-spherical milling surface 104, first conical surface 106 and second conical surface 108 has an abrasive surface coating 110. In the embodiment shown in FIG. 1, the abrasive is arc-welded carbide that has been applied to a magnetized mandrill. The process of arc-welding provides the abrasive to each of the surfaces that is oriented substantially perpendicularly to each surface. Although not completely capable of being described as a “true” grit size, the coarseness of the resulting surface can be roughly compared to that of 60 grit sand/carbide-coated paper.

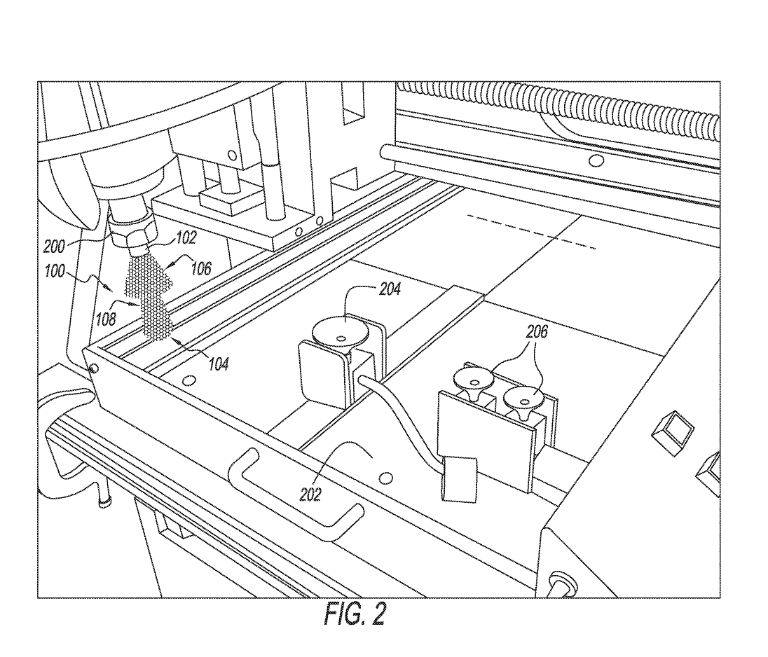

FIG. 2 shows milling head 100 according to FIG. 1 in place in a drill chuck 200 disposed above work surface 202. Associated with work surface 202 is a plurality of vacuum vise heads 204 and 206. In the embodiment shown in FIG. 2, there are two vacuum vise heads 206 for securing a rear (or heel) portion of an unfinished block of shoe support material thereto and a single vacuum vise head 204 for securing a front (or toe) portion of an unfinished block of shoe support material thereto. As is known to those of skill in the art, movements of drill chuck 200 and therefore of milling head 100 are controlled and guided by computer-implemented software. As such, fabricating a shoe support from an unfinished block of shoe support material can be substantially fully automated when the milling head of the present disclosure is used. This will be more clearly seen and understood with reference to the FIGS. that follow

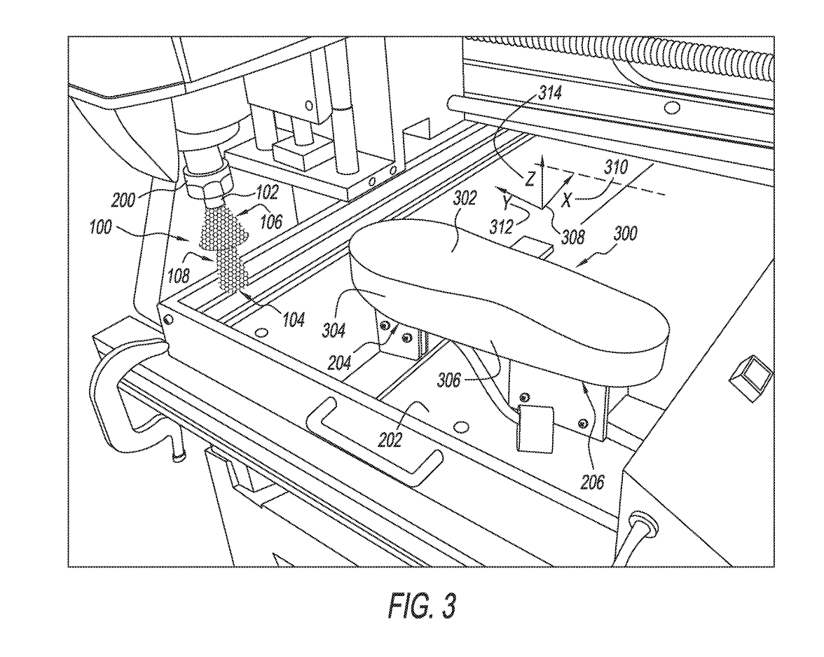

FIG. 3 shows the milling head 100 according to FIG. 1 secured in drill chuck 200 above work surface 202 as shown in FIG. 2. In FIG. 3, an unfinished block of shoe support material 300 is secured to vacuum vise heads 204 and 206. Unfinished block of shoe support material 300 has a top surface 302, a perimeter surface 304 and a medial arch area 306 of the perimeter surface 304. As mentioned previously, drill chuck 200 is computer-controlled so as to be capable of moving in a plurality of directions, including those shown by axes 308. Axes 308 include an axis 310 in the “X” (lateral) direction, an axis 312 in the “Y” (longitudinal) direction and an axis 314 in the “Z” (vertical) direction relative to unfinished block of shoe support material. During operation, drill chuck 200 is directed by a computer implemented design program (not shown or described herein) to move milling head 100 in each of axis directions 310, 312 and 314 to contour the top surface 302, perimeter surface 304 and medial arch area 306 of perimeter surface 304 of unfinished block of shoe support material as required by the specifications of the particular shoe support being made.

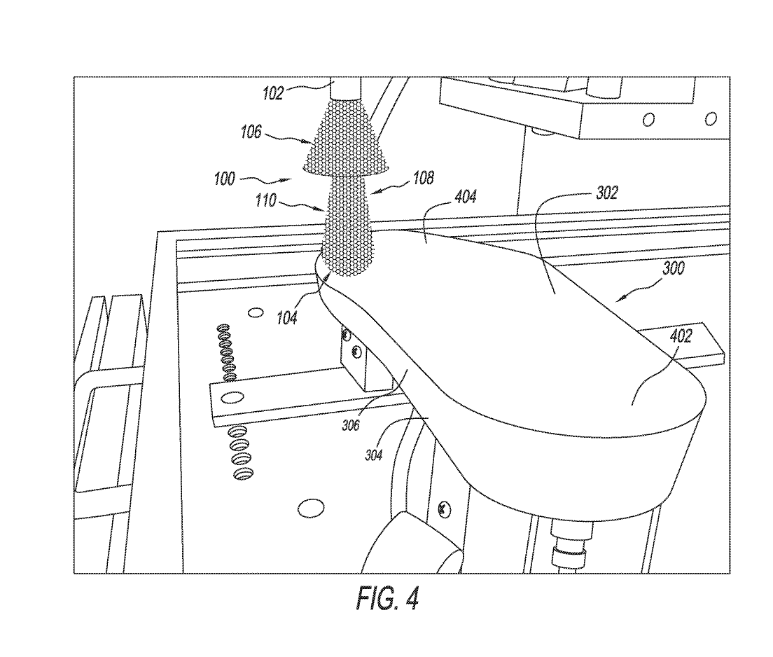

FIG. 4 shows milling head 100 in position for milling top surface 302 of unfinished block of shoe support material 300. As can be seen in FIG. 4, semi-spherical milling surface 104 is in the process of contouring a three-dimensional profile to top surface 302 of unfinished block of shoe support material 300. As can also be seen, the heel portion 402 of unfinished block of shoe support material 300 is thicker than the toe portion 404 of the unfinished block of shoe support material 300. Contouring a three-dimensional profile to top surface 302 is accomplished, as mentioned with respect to FIG. 3, by the computer implemented design program moving milling head 100 in each of the directions of axis 310 in the “X” direction, axis 312 in the “Y’ direction and axis 314 in the “Z” direction.

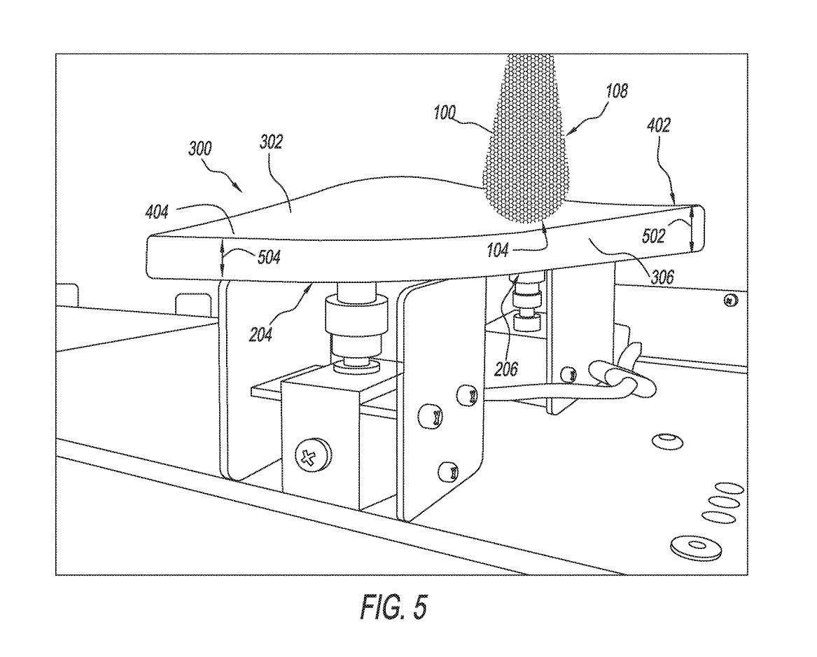

FIG. 5 is similar to FIG. 4 except that the view of the orientation of milling head 100 with respect to unfinished block of shoe support material 300 is shown differently. As is more clearly seen in FIG. 5, heel portion 402 has a greater thickness 502 than the thickness 504 of toe portion 404. The contouring of top surface 302 of unfinished block of shoe support material 300 by the computer implemented design program moving milling head 100 in each of the directions of axis 310 in the “X” direction, axis 312 in the “Y” direction and axis 314 in the “Z” direction can be more clearly appreciated with respect to FIG. 5.

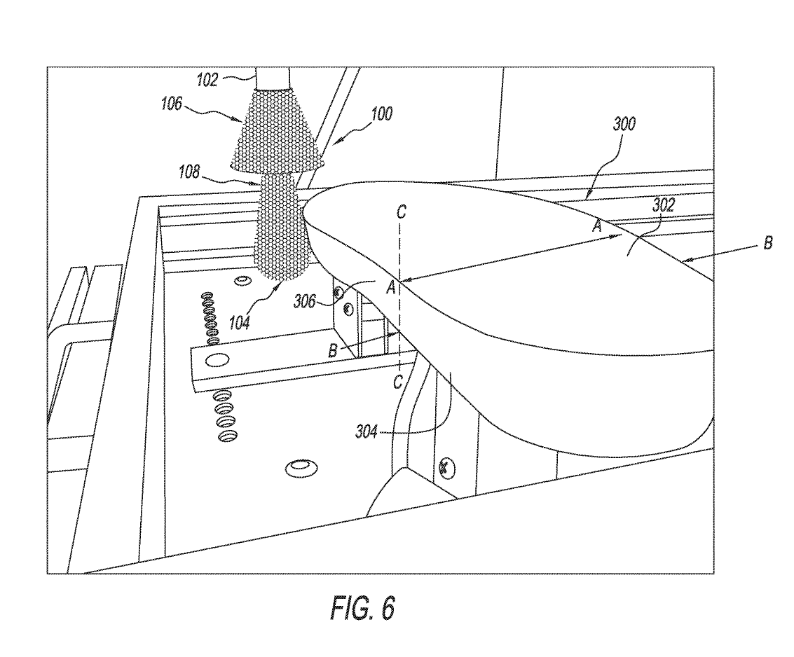

FIG. 6 shows milling head 100 in position for milling perimeter surface 304 of unfinished block of shoe support material 300. As can be seen in FIG. 6, second conical milling surface 108 is as an angle that is configured to impart a slight undercut to perimeter surface 304. That is to say that the width “A-A” across top surface 302 of unfinished shoe support material 300 is greater than the width “B-B” across the perimeter surface 306 of unfinished shoe support material 300 at the same longitudinal point “C-C” along the length of unfinished block of shoe support material 300. The undercut provided to perimeter surface 304 allows for ease of insertion and withdrawal of the finished shoe support into and out of a shoe.

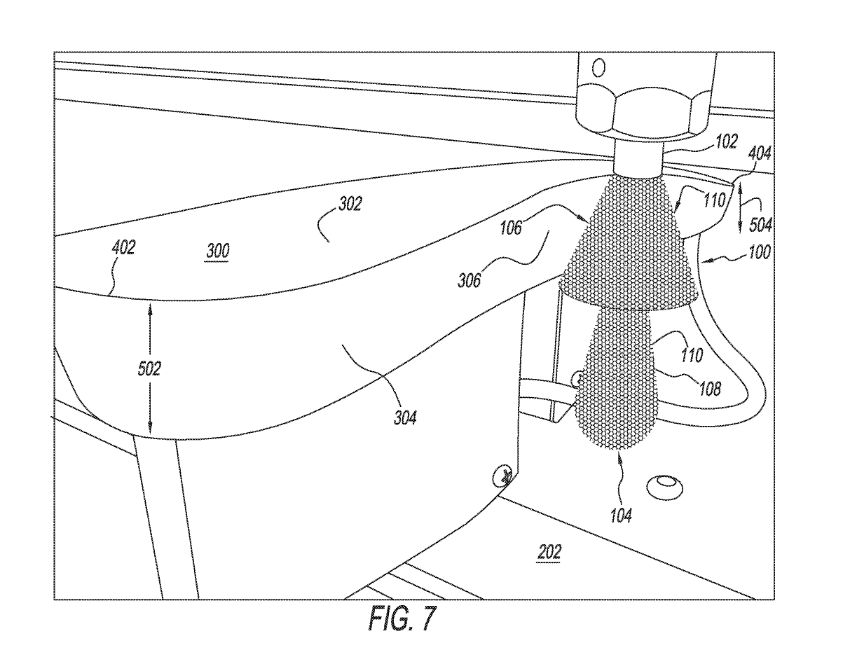

FIG. 7 shows milling head 100 in position for milling medial arch area 306 of unfinished block of shoe support material 300. As can be seen in FIG. 7, first conical milling surface 106 is at an angle that is configured to impart a more substantial undercut to perimeter surface 304 than second conical milling surface 108 imparts to perimeter surface 304. That is to say that the width “B-B” across medial arch area 306 of the perimeter surface 304 of unfinished shoe support material 300 is less than the width “B-B” provided after second conical milling surface 108 performs the undercut at the same longitudinal point “C-C” along the length of unfinished block of shoe support material 300. In operation, milling head 100 performs the undercut to unfinished block of shoe support material 300 by localized movement in “X” direction 310 toward the middle or inside area of unfinished block of shoe support material 300. The undercut provided to perimeter surface 304 by first conical milling head 106 allows for correct medial arch support to the unfinished block of shoe support material for the particular wearer.

As used herein, the terms “first”, “second”, “top” and “medial” are used merely for descriptive purposes and to provide for an understanding of the relative configuration of the embodiments of the present disclosure. The use of such terms is neither intended to nor necessary for the practice of the embodiments set forth in the present disclosure.

Although the present disclosure describes in detail certain embodiments, it is understood that variations and modifications exist known to those skilled in the art that are within the disclosure. Accordingly, the present disclosure is intended to encompass all such alternatives, modifications and variations that are within the scope of the disclosure as set forth in the disclosure.

What is claimed is:

1. A milling head having a plurality of milling surfaces for forming a shoe support from an unfinished block of support material, the milling head comprising:
at least a first angled undercutting surface; and
a curved surface,
wherein each surface is provided with a cutting surface,
wherein the at least first angled undercutting surface is configured to perform milling a milling operation on a perimeter surface of the unfinished block of support material, and
wherein the curved surface is configured to perform milling on a top surface of the unfinished block of support material.

2. The milling head according to claim 1, further comprising:
at least a second undercutting surface provided with a cutting surface,
wherein the second angled undercutting surface is configured to perform a milling operation on the medial arch area of the perimeter surface of the unfinished block of support material.

3. The milling head according to claim 1, further comprising: an attachment means configured for insertion into a chuck of a drill.

4. The milling head according to claim 2, further comprising: an attachment means configured for insertion into a chuck of a drill.

5. The milling head according to claim 3, wherein the curved surface is disposed distal the attachment means and the at least first angled undercutting surface is disposed between the attachment means and the curved surface.

6. The milling head according to claim 4, wherein the curved surface is disposed distal the attachment means and the at least first angled undercutting surface and the at least second undercutting surfaces are disposed between the attachment means and the curved surface.

7. The milling head according to claim 1, wherein the at least first angled undercutting surface and the curved surface are integrally formed into a unitary structure.

8. The milling head according to claim 2, wherein the at least first angled undercutting surface, the at least second angled undercutting surface and the curved surface are integrally formed into a unitary structure.

9. The milling head according to claim 3, wherein the at least first angled undercutting surface, the at least second angled undercutting surface, the curved surface and the attachment means are integrally formed into a unitary structure.

10. The milling head according to claim 4, wherein the at least first angled undercutting surface, the at least second angled undercutting surface, the curved surface and the attachment means are integrally formed into a unitary structure.

11. The milling head according to claim 3, wherein the at least first angled undercutting surface, the curved surface and the attachment means are connected to one another by threading, spring clips, set screws, spring loaded locking pins and any combinations of the foregoing.

12. The milling head according to claim 4, wherein the at least first angled undercutting surface, the at least second angled undercutting surface, the curved surface and the attachment means are connected to one another by threading, spring clips, set screws, spring loaded locking pins and any combinations of the foregoing.

13. The milling head according to claim 1, wherein the milling head is configured to perform the milling operation of the perimeter surface and the top surface by high speed rotation, oscillation, vibration and any combinations of the foregoing.

14. The milling head according to claim 2, wherein the milling head is configured to perform the milling operation of the perimeter surface, the medial arch area of the perimeter surface and the top surface by high speed rotation, oscillation, vibration and any combinations of the foregoing.

15. The milling head according to claim 1, wherein the at least first angled undercutting surface comprises a conical surface, and wherein the curved surface comprises a semi-spherical surface.

16. The milling head according to claim 2, wherein each of the at least first angled undercutting surface and the second angled undercutting surface comprise a conical surface, and wherein the curved surface comprises a semi-spherical surface.

17. The milling head according to claim 1, wherein each cutting surface comprises an abrasive, a knife-like cutting surface, saw teeth, or any combinations of the foregoing.

18. The milling head according to claim 2, wherein each cutting surface comprises an abrasive, a knife-like cutting surface, saw teeth, or any combinations of the foregoing.

19. A milling head having a plurality of milling surfaces for forming a shoe support from an unfinished block of support material, the milling head comprising:
an attachment end;
a semi-spherical milling surface for shaping a top surface of the unfinished block of shoe support material;
at least a first conical milling surface for shaping a perimeter surface of the unfinished block of shoe support material; and
at least a second conical milling surface for shaping a medial arch area of the perimeter surface of the unfinished block of shoe support material,
wherein the semi-spherical milling surface is disposed distal to the attachment end,
wherein the at least first and at least second conical milling surfaces are disposed between the attachment end and the semi-spherical milling surface, and
wherein each of the semi-spherical milling surface, the at least first conical milling surface and at least second conical milling surface is coated with an abrasive.

20. The milling head according to claim 19, wherein the at least first conical milling surface is disposed adjacent the semi-spherical milling surface and the at least second conical milling surface is disposed adjacent the attachment end.

21. The milling head according to claim 19, wherein the attachment end, the semi-spherical milling surface, the at least first conical milling surface and the at least second conical milling surface are of a unitary structure.

22. A method of forming a shoe support from an unfinished block of support material comprising:
providing a milling head comprising:
at least a first angled undercutting surface;
at least a second angled undercutting surface; and
a curved surface,
wherein each surface has a cutting surface,
placing an unfinished block of shoe support material in a position on a support,
wherein the support firmly holds the unfinished block of shoe support material in place and provides for exposing the perimeter and medial arch surfaces to the action of the milling head,
wherein the unfinished block of shoe support material has a top surface, a perimeter surface and a medial arch area of the perimeter surface;
shaping the top surface with the curved surface;
undercutting the perimeter surface with the at least first angled undercutting surface, and
undercutting the medial arch area of the perimeter surface with the at east second angled undercutting surface,
wherein the shaping of the top surface, the undercutting of the perimeter surface and the undercutting of the medial arch area of the perimeter surface is performed by moving the milling head in any combination of an “X” direction, a “Y” direction and a “Z” direction, and
wherein the undercutting of the perimeter surface and the undercutting of the medial arch area of the perimeter surface are performed without removing the shoe support material from position on the support.

23. The method according to claim 22, wherein the milling head further comprises:
a chuck shaft configured for insertion into a chuck of a drill.

24. The method according to claim 23, wherein the curved surface is disposed distal the chuck shaft and the at least first and at least second angled undercutting surfaces are disposed between the chuck shaft and the curved surface.

25. The method according to claim 22, wherein the at least first angled undercutting surface, the at least second angled undercutting surface and the curved surface are integrally formed into a unitary structure.

26. The method according to claim 23, wherein the at least first angled undercutting surface, the at least second angled undercutting surface, the curved surface and the chuck shaft are integrally formed into a unitary structure.

27. The method according to claim 22, wherein the at least first angled undercutting surface, the at least second angled undercutting surface and the curved surface are connected to one another by threading, spring clips, set screws, spring loaded locking pins and any combinations of the foregoing.

28. The method according to claim 23, wherein the at least first angled undercutting surface, the at least second angled undercutting surface, the curved surface and the chuck shaft are connected to one another by threading, spring clips, set screws, spring loaded locking pins and any combinations of the foregoing.

29. The method according to claim 22, wherein the milling head is configured to perform the milling operation of the perimeter surface, the medial arch area of the perimeter surface and the top surface by high speed rotation, oscillation, vibration and any combinations of the foregoing.

30. The method according to claim 22, wherein the at least first angled undercutting surface and the at least second angled undercutting surface each comprises a conical surface, and wherein the curved surface comprises a semi-spherical surface.
